(19) United States
(12) Patent Application Publication
(10) Pub. No.: US 2010/0245017 A1
(43) Pub. Date: Sep. 30, 2010

(54) PRODUCTION METHOD FOR A MULTI-LAYER TRANSFORMER WINDING HAVING INSULATING LAYER

(75) Inventors: Roland HOFFMANN, Brilon (DE); Christian Gruettner, Ruethen (DE); Karl Zillmann, Marsberg (DE); Benjamin Weber, Winterberg (DE); Joerg Nelges, Mosbach (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/776,716

(22) Filed: May 10, 2010

Related U.S. Application Data
(63) Continuation of application No. PCT/EP2008/009051, filed on Oct. 25, 2008.

(30) Foreign Application Priority Data
Nov. 10, 2007 (DE) 10 2007 053 685.4

(51) Int. Cl. H01F 27/28; H01F 41/06

(52) U.S. Cl. 336/222; 29/605

(57) ABSTRACT

A method is disclosed for producing a multi-layer transformer winding. During or after the winding of a conductor layer around a winding body, a layer of electrically insulating material can be applied on the radially outer surface thereof. A dry fiber composite can be used as the insulating material. The fiber composite can be bonded into an insulating layer by heating the transformer winding to a composite temperature.

### RELATED APPLICATIONS

This application claims priority as a continuation application under 35 U.S.C. §120 to PCT/EP2008/009051, which was filed as an International Application on Oct. 25, 2008 designating the U.S., and which claims priority to German Application 10 2007 053 685.4 filed in Germany on Nov. 10, 2007. The entire contents of these applications are hereby incorporated by reference in their entireties.

### FIELD

The disclosure relates to a production method for a multilayer transformer winding, and to a multilayer transformer winding.

### BACKGROUND INFORMATION

It is known that when producing windings for power transformers, for example in the rating range from a few kVA up to more than 50 MVA, a plurality of conductor layers can be wound around a winding former, and that these conductor layers can be electrically insulated from one another in addition to the insulation layer surrounding the conductor. This insulation can be formed to reduce air enclosures, because they can have a negative influence on the electrical insulation capability of the insulation material.

According to DE4445423 B4, for example, the insulation stratum is produced by a glass fabric in the form of a ribbon which is wound repeatedly in a helical shape around the conductor layer to be insulated, with this so-called glass roving being impregnated with liquid resin immediately before the winding process. After completion of the process of winding the entire transformer winding, this transformer winding is heated in order to cure the resin, for example to 160° C., and is then cooled down to ambient temperature.

During this procedure, the winding process of the insulation strata is carried out with the insulation material in the wet state, specifically the resin-impregnated state, and in consequence takes a comparatively long time.

### SUMMARY

A method is disclosed for producing a multilayer transformer winding, comprising: winding a conductor layer around a winding former; applying during or after the winding, a stratum of electrical insulation material to a radially outer surface of the conductor layer, the insulation material including a dry fiber composite material; and heating the conductor layer to a bonding temperature to form an insulation stratum.

A multilayer transformer winding is disclosed comprising: at least two winding layers; and at least one stratum of insulation material between the two winding layers, wherein the insulation material is a dry fiber composite material heat bonded to the winding layers to form an insulation stratum.

A multilayer transformer winding is disclosed comprising: at least two winding layers; and at least one insulation stratum between the winding layers wherein insulation material of the at least one insulation strata contains a material additive which expands irreversibly when heated for a first time to a specific expansion temperature.

### BRIEF DESCRIPTION OF THE DRAWINGS

The disclosure, further embodiments and further advantages will be described in more detail with reference to the exemplary embodiments which are illustrated in the drawings, in which:

FIG. 1 shows an exemplary finished first transformer winding before it is heated for a first time to a bonding temperature; and

FIG. 2 shows an exemplary second transformer winding, after it has been heated for a first time to an expansion temperature.

### DETAILED DESCRIPTION

An exemplary production method is disclosed which can quickly form a transformer winding.

As disclosed herein, an exemplary production method for a multilayer transformer winding can involve use of a dry fiber composite material as an insulation material, and this material can be bonded to form an insulation stratum, by heating the transformer winding to a desired and/or predetermined bonding temperature.

The use of a dry insulation material can make it possible to considerably reduce the time for the production process for the insulation stratum, for example by winding the insulation material at a higher speed. The production effort for the transformer winding can likewise be advantageously reduced, since the insulation material is not impregnated in situ. By way of example, this can be done in advance by the manufacturer of the insulation material, or in a process which is independent of the winding process. This can result in a completely impregnated and dried insulation material as a semi-finished product for manufacture of the transformer winding.

Delivery, may, for example, be in the form of an insulation material which is wound around a coil former and is in the form of a ribbon, which can be particularly advantageous for its further processing. This material in the form of a ribbon can, for example, be wound repeatedly in a helical shape around the conductor layer to be insulated, thus achieving a desired design-dependent minimum insulation thickness around the entire circumference of the conductor layer. During the winding process, care can be taken to ensure that the respective ribbons are wound as closely as possible, and without air enclosures.

Insulating materials such as fabricated ribbons composed of glass, polyester or another insulation material with adequate temperature stability during the subsequent heating process can be used as exemplary carrier materials for the impregnation. By way of example, the impregnation material may be a resin.

In an exemplary method, after completion of the process of winding the multilayer transformer winding with insulation, the transformer winding can be heated to a specific bonding temperature. This liquefies the impregnation of the pre-impregnated insulation material, and the turns of the fiber composite material which are located alongside one another are bonded to form a unit. Any cavities can be partially filled. By way of example, a heating process such as this can be carried out in an oven of suitable size. This can be followed by a cooling-down process to ambient temperature, during which the impregnation cures.

It has been found to be advantageous in an exemplary method as disclosed herein for a material additive to be added to the insulation material or to the impregnation of the insulation material which is in the form of a ribbon, which material additive expands irreversibly when a specific expansion temperature is first reached.

A material additive such as this is, for example, the product “Expancel” which has a single, irreversible expansion phase at an expansion temperature of, for example, 160° C. (although any suitable material additive having any desired, suitable expansion temperature can be used). In an exemplary method, the higher temperature of the bonding temperature and expansion temperature should in each case be chosen for the heating process.

This is because there may be cavities between the individual conductors of a conductor layer after the process of winding the transformer winding. Cavities can also occur during the winding of the individual webs of the dry insulation material. Cavities such as these can adversely affect the insulation capability of the insulation material, and can be advantageously filled by a material additive such as this. The insulation capability of the overall insulation stratum can thus be further increased, exceeding the insulation capability of known insulation stratum, produced in the wet state.

When considering the proportion of expansive material, care should be taken to ensure that the increase in volume which occurs on heating for the first time to a specific expansion temperature corresponds approximately to, for example, the expected volume of the cavities to be filled.

In a further exemplary refinement of the production method disclosed herein, a stratum of electrical insulation material can be first applied to a radially outer surface of the winding former, before the process of winding the radially innermost conductor layer.

This can further increase the insulation capability of the completed transformer winding.

In an exemplary variant of the production method according to the disclosure, at least one cooling channel, which runs in the axial direction, can be first fitted to the radially outer surface of the winding before the start of the winding of at least one of the process conductor layers.

Power transformers frequently use cooling channels to transport away heat losses which occur during operation. Channels such as these normally extend over the entire axial winding length. By way of example, a cooling channel such as this may be formed from two tube elements pushed one inside the other, and the exemplary cooling channel can run between two conductor layers around an entire circumference of the winding axis of the transformer winding, along its entire axial length.

In an exemplary development of the production method, insulation material can be applied to the radially outer surface of the cooling channel before a conductor layer which is radially adjacent on the outside is wound.

This can make it possible to further increase the dielectric strength of the transformer winding.

According to the disclosure, the cooling channel can be produced from electrical insulation material.

This can result in the cooling channel carrying out the insulation function between the conductor layers surrounding it and there is no need for an additional insulation stratum.

An exemplary multilayer transformer winding is disclosed having at least one stratum of insulation material between the winding layers, wherein the insulation material is a dry fiber composite material, which can be bonded to form an insulation stratum by heating the transformer winding to a predetermined bonding temperature.

A winding such as this can be produced particularly quickly, because the insulation material is dry.

In one exemplary embodiment of the transformer winding, the insulation material contains a material additive which can expand irreversibly when heated for a first time to a specific expansion temperature.

This can make it possible to dramatically increase the dielectric strength and the life of the insulation stratum, because any cavities which are present in the insulation material before the winding is heated to the expansion temperature or bonding temperature can be filled by the volume expansion on reaching the expansion temperature.

In a further exemplary refinement of the transformer winding according to the disclosure, the transformer winding can include a plurality of subareas, which are each located axially alongside one another, and which each have a plurality of conductor layers, which are located radially one above the other. At least two of the conductor layers, which are contained therein and are axially adjacent to one another, in at least one conductor layer stratum, can be galvanically isolated from one another in respective subareas in the boundary area.

This is because it can be expedient for insulation reasons to reduce the voltage load of adjacent conductors by a transformer winding design such as this, or to arrange two completely galvanically isolated winding conductors (e.g., winding conductors which are not directly galvanically connected to one another) in one winding.

Further exemplary refinement options for the production method according to the disclosure and for the transformer winding resulting from it will be apparent to those skilled in the art based on the embodiments disclosed herein.

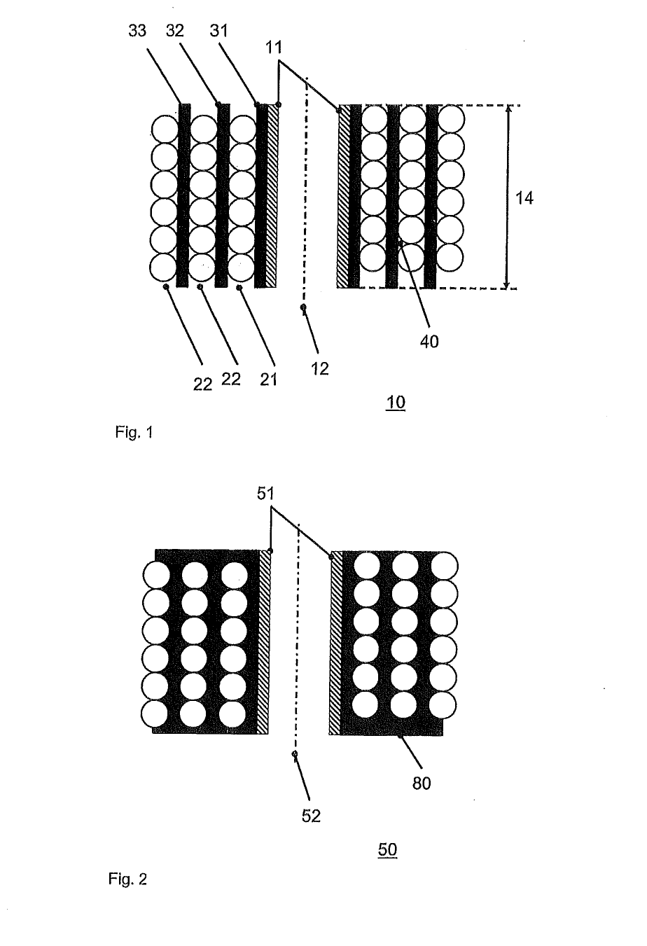

FIG. 1 shows a first exemplary transformer winding 10, finished according to the disclosure, before heating for a first time to a bonding temperature, illustrated schematically. Before the start of manufacture, a winding former 11 which governs an unobstructed internal diameter of the transformer winding to be manufactured, can be positioned on a suitable manufacturing platform.

An impregnated and dry fiber composite material foremed, for example as a ribbon, can be provided, for example, by the supplier on a roll and wound in a plurality of helical layers around the winding former 11 until a desired (e.g., predetermined) minimum insulation stratum thickness is reached. However, it is quite possible to first of all choose a composite material similar to a thread for the process of winding a stratum, in order to compensate for uneven areas on the surface of the conductor layer and then to form this into a composite material in the form of a ribbon. A winding process is carried out, for example, with the aid of a winding machine, wherein a winding arm, which is arranged above the coil to be manufactured, is mounted at one of its ends such that it can rotate about the rotation axis 12, and at its other end has the capability to hold the delivered roll of the fiber composite material. This can allow the fiber composite material, which is in the form of a ribbon, to be applied easily by rotating the arm about the rotation axis 12.

After completion of the process of winding the first stratum of insulation material 31 of the first transformer winding 10, this stratum can, for example, be covered over an entire circumference of the winding former 11 and over its entire axial length 14 with a minimum overall stratum thickness of the dry insulation material, with the first winding 10 being rotationally symmetrical about the imaginary rotation axis 12. The minimum stratum thickness varies depending on the dielectric strength to be achieved for the insulation stratum, and may vary in range from, for example, about 1 mm up to about 20 mm. During winding, care can be taken to ensure that, as far as possible, there are no air enclosures in the wound insulation stratum.

In an exemplary method, a first conductor layer 21 is then applied, wherein a conductor which is surrounded by an insulation stratum is fitted in a helical shape over the entire winding length 14.

After this, analogously to the first stratum of insulation material 31, a second stratum of insulation material 32 can be applied to the first conductor layer 21, and a second conductor layer 22 is in turn wound thereon. Care can be taken to ensure that the first conductor layer 21 and the second conductor layer 22 are electrically connected at one of the two ends of the winding 10.

It should furthermore be noted that cavities 40 can be formed between adjacent conductors and in the strata of the insulation material 31, 32, 33, and these can reduce the dielectric strength of the insulation strata. According to exemplary embodiments, a reduction in the dielectric strength such as this does not adversely affect the fundamental functionality of the insulation strata, if the transformer winding is appropriately designed.

The finished transformer winding 10 can then be heated to a desired and/or specific minimum temperature, which can correspond to the bonding temperature and, for resin-based insulation systems, is in the temperature range from, for example, about 120° C. to about 160° C. A heating process such as this can be, for example, carried out in an oven of suitable size, with the heating time being designed such that the entire transformer winding is raised to the nominal temperature. Oven times in the range from 15 minutes up to several hours may result depending on the size of the winding, in a manner which will be apparent to those skilled in the art.

FIG. 2 shows a second exemplary finished transformer winding 50 with a similar winding configuration to the first transformer winding 10, but in contrast to FIG. 1, FIG. 2 shows the winding 50 after heating for a first time to a limit temperature. A material additive, which expands irreversibly on reaching the expansion temperature for the first time, was previously added to the insulation material. The heating temperature limit in this example corresponds to the higher temperature of the bonding temperature and expansion temperature.

The material additive can, for example, be added by applying an additional stratum of the material additive to the winding former 51 before application of the first stratum of insulation material, and by applying a further additional stratum of the material additive after the application of the first stratum of insulation material. An analogous procedure can be adopted in a corresponding manner for each further stratum of insulation material. Alternatively, for example, a material additive such as this can be added to the impregnation of a fiber composite material which is in the form of a ribbon during its production.

Material additives such as this which expand irreversibly on reaching an expansion temperature for the first time are known. For example, a product commercially known as “Expancel” is characterized by an exactly metered amount of a propellant enclosed in a gas-tight plastic sleeve with a size of only a few micrometers. When this micro-sphere is warmed or heated, the plastic sleeve softens, the propellant becomes gaseous and the micro-sphere expands irreversibly in a defined manner. However, other material additives with similar characteristics are also available, including those which work on different principles of operation, for example expansion as a result of chemical processes.

FIG. 2 also shows that the previous heating for the first time to the limit temperature results in the volume of the material additive expanding, and the cavities 40, which are indicated in FIG. 1, and the strata of insulation material 31, 32, 33, are now parts of the insulation area 80. There are advantageously no cavities in the insulation area 80, which has a plurality of insulation strata between the conductor layers.

When metering the amount of material additive, care can be taken to ensure that the increase in volume during expansion corresponds approximately to an expected volume of the cavities to be filled.

A further reduction in the volume of unfilled cavities in a finished winding can also be achieved by carrying out the heating process in the oven in conditions similar to a vacuum.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Manufactured first transformer winding before heating for the first time
11 Winding former of first transformer winding
12 Rotation axis of first transformer winding
14 Length of the first transformer winding
21 First conductor layer of first transformer winding
22 Second conductor layer of first transformer winding
31 First stratum of insulation material of first transformer winding
32 Second stratum of insulation material of first transformer winding
33 Third stratum of insulation material of first transformer winding
40 Cavity in first transformer winding
50 Manufactured second transformer winding after heating for the first time
51 Winding former of second transformer winding
52 Rotation axis of second transformer winding
80 Insulation area of second transformer winding

What is claimed is:

1. A method for producing a multilayer transformer winding, comprising:
winding a conductor layer around a winding former;
applying during or after the winding, a stratum of electrical insulation material to a radially outer surface of the conductor layer, the insulation material including a dry fiber composite material; and
heating the conductor layer to a bonding temperature to form an insulation stratum.

2. The method as claimed in claim 1, wherein the insulation material includes a material additive, which expands irreversibly when a specific expansion temperature is first reached.

3. The method as claimed in claim 2, comprising:
metering the material additive such that an increase in volume resulting from an amount of material additive corresponds approximately to a total volume of cavities contained in the transformer winding.

4. The method as claimed in claim 1, comprising:
applying a stratum of electrical insulation material to a radially outer surface of the winding former, before winding a radially innermost conductor layer of the multilayer transformer.

5. The method as claimed in claim 1, comprising:
fitting at least one cooling channel, which runs in the axial direction, to a radially outer surface of a partially completed winding before winding at least one of multiple conductor layers.

6. The method as claimed in claim 5, comprising:
applying insulation material to a radially outer surface of the cooling channel before a radially adjacent conductor layer is wound outside the cooling channel.

7. The production method as claimed in claim 5, comprising:
producing the cooling channel from electrical insulation material.

8. A multilayer transformer winding comprising:
at least two winding layers; and
at least one stratum of insulation material between the two winding layers, wherein the insulation material is a dry fiber composite material heat bonded to the winding layers to form an insulation stratum.

9. The multilayer transformer winding as claimed in claim 8, wherein the insulation material contains an irreversibly expanded material additive having a characteristic of expanding when heated for a first time to a specific expansion temperature.

10. The multilayer transformer winding as claimed in claim 8, comprising:
a plurality of subareas, which are each located axially alongside one another, and each have a plurality of conductor layers, which are located radially one above one another; and
at least two of the conductor layers contained within the subareas, axially adjacent to one another in at least one conductor layer stratum, which are galvanically isolated from one another.

11. A multilayer transformer winding comprising:
at least two winding layers; and
at least one insulation stratum between the winding layers wherein insulation material of the at least one insulation strata contains a material additive which expands irreversibly when heated for a first time to a specific expansion temperature.

12. The method as claimed in claim 3, comprising:
applying a stratum of electrical insulation material to a radially outer surface of the winding former, before winding a radially innermost conductor layer of the multilayer transformer.

13. The method as claimed in claim 12, comprising:
fitting at least one cooling channel, which runs in the axial direction, to a radially outer surface of a partially completed winding before winding at least one of multiple conductor layers.

14. The multilayer transformer winding as claimed in claim 9, comprising:
a plurality of subareas, which are each located axially alongside one another, and each have a plurality of conductor layers, which are located radially one above one another; and
at least two of the conductor layers contained within the subareas, axially adjacent to one another in at least one conductor layer stratum, which are galvanically isolated from one another.
